(19) United States
(12) Patent Application Publication
(10) Pub. No.: US 2007/0147066 A1
(43) Pub. Date: Jun. 28, 2007

(54) Lighting device including customized retarder and display device including same

(75) Inventors: Gary T. Boyd, Woodbury, MN (US); Robert M. Emmons, St. Paul, MN (US); Mark B. O'Neill, Stillwater, MN (US); Nicholas Roland, Oakdale, MN (US); Philip E. Watson, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/319,829

(22) Filed: Dec. 28, 2005

(51) Int. Cl. F21V 8/00

(52) U.S. Cl. 362/600

(57) ABSTRACT

Lighting devices are disclosed that include a light source, a linear reflective polarizer optically coupled to the light source, a back reflector configured and disposed to reflect light that has been reflected by the linear reflective polarizer back toward the input surface thereof, one or more optical elements having a total non-zero retardance Rs and disposed between the linear reflective polarizer and the back reflector, and a customized retarder. The customized retarder has a retardance Rc such that a total retardance of the one or more optical elements and the customized retarder, Rs+Rc, approaches λ/4+n λ/2. The one or more optical elements, the customized retarder and the back reflector are characterized by a total depolarization of no more than 66%. Display devices including such lighting devices are also disclosed.

### FIELD OF THE INVENTION

The present invention relates to display devices and lighting devices including retarders and linear reflective polarizers.

### BACKGROUND

Microprocessor-based devices that include electronic displays for conveying information to a viewer have become nearly ubiquitous. Mobile phones, handheld computers, personal digital assistants, electronic games, car stereos and indicators, public displays, automated teller machines, in-store kiosks, home appliances, computer monitors, televisions and others are all examples of devices that include information displays viewed on a daily basis. Many of the displays provided on such devices are liquid crystal displays (“LCDs”).

Unlike cathode ray tube (CRT) displays, LCDs do not emit light and, thus, require a separate light source for viewing images formed on such displays. For example, a source of light can be located behind the display, which is generally known as a “backlight.” Some traditional backlights include one or more brightness enhancing films having linear prismatic surface structures, such as Vikuiti™ Brightness Enhancement Film (BEF), available from 3M Company. One or more reflective polarizer films are also typically included into a backlight, such as Vikuiti™ Dual Brightness Enhancement Film (DBEF) or Vikuiti™ Diffuse Reflective Polarizer Film (DRPF), both available from 3M Company. DBEF and/or DRPF transmit light with a predetermined polarization. Light with a different polarization is reflected back into the backlight, where the polarization state of that light is usually scrambled, e.g., with diffusers and other “random” polarization converting elements, and the light is fed back into the reflective polarizer. This process is usually referred to as “polarization recycling.”

### SUMMARY OF THE INVENTION

In one exemplary implementation, the present disclosure is directed to lighting devices including a light source and a linear reflective polarizer having an input surface optically coupled to the light source and an output surface disposed opposite the input surface. The linear reflective polarizer is configured to transmit at least a substantial amount of light having a first polarization state and reflect at least a substantial amount of light having a second polarization state different from the first polarization state. The lighting devices further include a back reflector configured and disposed to reflect light that has been reflected by the linear reflective polarizer back toward the input surface thereof, one or more optical elements having a total non-zero retardance Rs and disposed between the linear reflective polarizer and the back reflector, and a customized retarder having a retardance Rc. A total retardance of the one or more optical elements and the customized retarder, Rs+Rc, approachesλ/4+nλ/2. The one or more optical elements, the customized retarder and the back reflector are characterized by a total depolarization of no more than 66%.

In another exemplary implementation, the present disclosure is directed to lighting devices including a light source and a linear reflective polarizer having an input surface optically coupled to the light source and an output surface disposed opposite the input surface. The linear reflective polarizer is configured to transmit light having a first polarization state and reflect light having a second polarization state different from the first polarization state. The lighting devices also include a back reflector configured and disposed to reflect light that has been reflected by the linear reflective polarizer toward the input surface thereof. A light distributing element is disposed between the back reflector and the linear reflective polarizer and having an input facet optically coupled to the light source and an output facet optically coupled to the input surface of the linear reflective polarizer. One or more optical films are disposed between the back reflector and the linear reflective polarizer, the light-distributing element and the one or more optical films having a non-zero total retardance Rs. The lighting devices further include a customized retarder having a retardance Rc such that the total retardance of the light-distributing element, the one or more optical films and the customized retarder, Rs+Rc, approaches λ/4+n λ/2. The light-distributing element, the one or more optical films, the customized retarder and the back reflector are characterized by a total depolarization of no more than 66%.

In yet another exemplary implementation, the present disclosure is directed to lighting devices including a light source and a linear reflective polarizer having an input surface optically coupled to the light source and an output surface disposed opposite the input surface. The linear reflective polarizer is configured to transmit light having a first polarization state and reflect light having a second polarization state different from the first polarization state. The lighting devices also include a back reflector configured and disposed to reflect light that has been reflected by the linear reflective polarizer back toward the input surface thereof, one or more optical elements having a total non-zero retardance Rs and disposed between the back reflector and the linear reflective polarizer, and a customized retarder disposed adjacent to the linear reflective polarizer. The customized retarder has a retardance Rc such that the total retardance of the one or more optical elements and the customized retarder, Rs+Rc, approaches λ/4+n or more optical elements, the customized retarder and the back reflector are characterized by a total depolarization of no more than 66%.

These and other aspects of the lighting devices and display devices according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, wherein:

FIG. 1 is a schematic cross-sectional view of an exemplary display device and an exemplary lighting device constructed according to the present disclosure;

FIG. 2 is a schematic cross-sectional view of an exemplary display device and a lighting device constructed according to another exemplary embodiment of the present disclosure; and

FIG. 3 is a diagram illustrating some physical properties and design considerations of an exemplary lighting device constructed according to the present disclosure;

FIG. 4 shows series of plots (the individual plots being shown in FIGS. 5-29) of calculated relative brightness based on the configuration shown in FIG. 3 as a function of the amount of retardance of a customized retarder (vertical axes of the individual plots) and of the orientation of the slow axis of the customized retarder (horizontal axes of the individual plots) for different total retardances (0, 22.5, 45, 66.5 and 90 degrees) of additional optical elements (vertical axis) and different orientations (0, 22.5, 45, 66.5 and 90 degrees) of the combined slow axis of the additional optical elements (horizontal axis); and

FIGS. 5-29 each show a plot of calculated relative brightness based on the configuration shown in FIG. 3 as a function of the amount of retardance of a customized retarder (vertical axis) and of the orientation of the slow axis of the customized retarder (horizontal axis) for a particular total retardance of additional optical elements (0, 22.5, 45, 67.5 or 90 degrees) and a particular orientation of the combined slow axis of the additional optical elements (0, 22.5, 45, 67.5 or 90 degrees).

### DETAILED DESCRIPTION

Performance of a display device, such as an LCD, is often judged by its brightness. Use of a larger number of light sources and/or of brighter light sources is one way of increasing brightness of a display. However, additional light sources and/or brighter light sources consume more energy, which typically requires allocating more power to the display device. For portable devices this may correlate to decreased battery life. Adding light sources to the display device or using brighter light sources may increase the cost and weight of the display device.

Another way of increasing brightness of a display device involves more efficiently utilizing the light that is available within the display device or within its lighting device such as a backlight. For example, light within a display device or a lighting device may be “polarization recycled” using a reflective polarizer, such that the reflective polarizer transmits at least a substantial amount of light having a desired polarization characteristic and reflects at least a substantial amount of light having a different polarization characteristic. The polarization of the reflected (i.e., rejected) light then may be randomized by other elements in the lighting device and fed back to the reflective polarizer, whereupon the recycling sequence repeats.

However, although the polarization recycling mechanism described above is very effective in providing a brighter display with the same power allocation, at least some light is usually lost with each repeating recycling sequence. For example, some light can be lost due to Fresnel reflections at the interfaces of the optical elements present in the display device and due to light absorption by the materials of the optical elements, the effects of which may become significant with multiple passes of light.

Accordingly, the present disclosure is directed to lighting devices, such as backlights, that include reflective polarizers and customized retarders and display devices including such lighting devices. Customized retarders included into exemplary embodiments of the present disclosure are intended to aid in reducing the number of recycling sequences by facilitating the conversion of the reflected/rejected polarization into polarization that can be transmitted by the reflective polarizer, as described in more detail below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms a “an”, and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

The term “polarization” refers to plane or linear polarization, circular polarization, elliptical polarization, or any other nonrandom polarization state in which the electric vector of the beam of light does not change direction randomly, but either maintains a constant orientation or varies in a systematic manner. With in-plane polarization, the electric vector remains in a single plane, while in circular or elliptical polarization, the electric vector of the beam of light rotates in a systematic manner.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The term “in-plane birefringence” is understood to be the difference between the in-plane indices (nₓ and n_{y}) of refraction. The term “out-of-plane birefringence” is understood to be the difference between one of the in-plane indices (nₓ or n_{y}) of refraction and the out-of-plane index of refraction n_{z}.

The retardance of a birefringent film is the phase difference introduced when light passes through a medium of a thickness (d), based on the difference in the speeds of advance of light polarized along the slow axis, which is the axis orthogonal to the light propagation direction and characterized by a larger value of the refractive index, and along the axis or direction normal thereto. In some exemplary embodiments utilizing oriented polymeric films at normal and nearly normal incidence of light, the slow axis is collinear with the direction in which the film has been stretched, and in that case thickness d is the thickness of the film.

Generally, the retardance or retardation is represented by the product Δn※d, where Δn is the difference in refractive indexes along the slow axis and the direction normal thereto, and d is the medium thickness traversed by the light.

The term “in-plane retardation” refers to the product of the difference between two orthogonal in-plane indices of refraction times the thickness of the optical element.

The term “out-of-plane retardation” refers to the product of the difference of the index of refraction along the thickness direction (z direction) of the optical element and one in-plane index of refraction times the thickness of the optical element. Alternatively, this term refers to the product of the difference of the index of refraction along the thickness direction (z direction) of the optical element and the average of in-plane indices of refraction times the thickness of the optical element.

Those of ordinary skill in the art will readily appreciate that when light is incident at an angle with respect to a surface normal of a medium characterized by both in-plane and out-of-plane birefringences, the light encounters components of both the in-plane and the out-of-plane birefringences. Generally, retardance is a function of (i) the thickness of the optical element such as a film, (ii) nₓ, n_{y}, n_{z}, (iii) the angle of incidence of light, and (iv) the angle between the projection of the plane of incidence onto the film and the slow axis of the film. Calculation of the effective refractive indices and direction of refracted rays as functions of the angle of incidence for the case where the projection of the plane of incidence onto the film coincides with the slow axis of the film is considered by Brehat et al., J. Phys. D: Appl. Phys. 26 (1993) 293-301, the contents of which are hereby incorporated by reference herein. The general case, where the projection of the plane of incidence onto the film makes an angle with respect to the slow axis of the film, is considered by Simon M. C., J. Opt. Soc. Am. A 4 (1987) 2201, the contents of which are hereby incorporated by reference herein.

In any case, a person of ordinary skill in the art can determine optimum retardance for any given angle of incidence using commercially available software that allows one to simulate series of experiments to determine the effect of a birefringent film on polarization state of transmitted light. One example of such software is DIMOS brand software available from Autronic-Melchers GmbH.

Lighting Devices and Display Devices

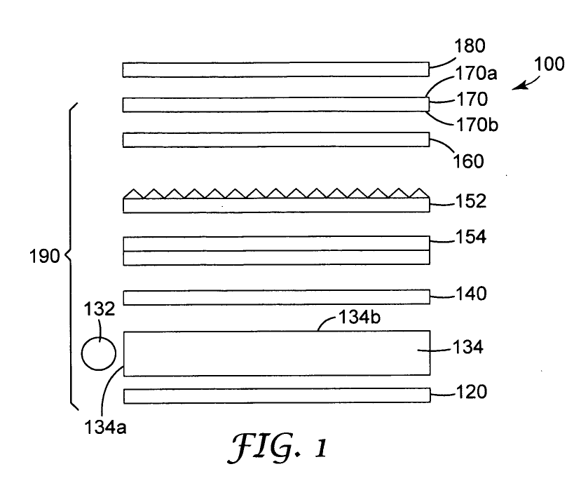

FIG. 1 shows an exemplary display device 100 including an exemplary lighting device 190 constructed according to the present disclosure, a display panel 180 and, optionally, one or more additional optical films and/or components (not shown) as desired for a particular application. Suitable display panels include liquid crystal display panels (LCD panels), such as twisted nematic (TN), single domain vertically aligned (VA), optically compensated birefringent (OCB) liquid crystal display panels and others. The display panel and the lighting device 190 are arranged such that the display panel 180 is disposed between the lighting device 190 and a viewer (not shown), such that the lighting device 190 supplies light to the display panel 180. In this exemplary embodiment, the lighting device 190 can be referred to as a backlight.

The exemplary lighting device 190 includes a reflective polarizer 170. The reflective polarizer 170 has a light input surface 170b and a light output surface 170a, and it is disposed such that the light output surface 170a faces the display panel 180. In some exemplary embodiments, the reflective polarizer 170 is a linear reflective polarizer. The reflective polarizer 170 plane transmits at least a substantial amount of light having a first polarization characteristic and reflects at least a substantial amount of light having a second polarization characteristic, different from the first polarization characteristic. Preferably, the reflective polarizer 170 transmits at least 50%, more preferably at least 70%, and even more preferably at least 90%, of light at normal incidence having the first polarization characteristic and transmits less than 50%, more preferably less than 30%, and even more preferably less than 10% of light at normal incidence having the second polarization characteristic. Examples of suitable linear reflective polarizers include but are not limited to multilayer reflective polarizers, wire grid polarizers, Brewster's angle polarizers, such as structured surface Brewster's angle polarizers, and diffuse reflective polarizers including a continuous phase and a disperse phase disposed within the continuous phase. In some exemplary embodiments, a circular reflective polarizer can be used in combination with a quarter-wave retarder in place of a linear reflective polarizer, and, for the purposes of the present disclosure, such combination shall be considered covered by the term “linear reflective polarizer.” In such exemplary embodiments, the quarter-wave retarder shall be used at the light-input surface of the reflective polarizer such that substantially linearly polarized light is reflected back from the film combination, in which the films may be disposed next to each other, laminated or otherwise combined.

An exemplary multilayer reflective polarizer includes one or more first polymer layers, one or more second polymer layers, and optionally, one or more polymer skin (non-optical layers) layers. In some exemplary embodiments, the first polymer layers are optical polymer layers that are capable of becoming birefringent once oriented or stretched, while the second polymer layers are optical polymer layers that do not become birefringent when stretched. In such exemplary embodiments, the second polymer layer has an isotropic index of refraction, which is usually selected to be different from the indices of refraction of the first polymer layers in one in-plane direction after orientation or stretching, while substantially matching the indices of refraction of the first polymer layers in another in-plane direction. In other exemplary embodiments, the second polymer layers may have other isotropic refractive indexes or they may be negatively or positively birefringent. Thus, the first polymer layers are different than the second polymer layers. In many embodiments, first polymer layers have a different polymer composition than the second polymer layers.

The first and second optical layers and, optionally, one or more of the non-optical layers are typically placed one on top of the other to form a stack of layers. The optical layers are arranged as alternating optical layer pairs where each optical layer pair includes a first polymer layer and a second polymer layer to form a series of interfaces between layers with different optical properties. The interface between the two different optical layers (e.g., first and second layers) forms a light reflection plane, if the indices of refraction of the first and second polymer layers are different in at least one direction, e.g., at least one of x, y, and z directions. Light polarized in a plane parallel to the direction in which the indices of refraction of the two layers are approximately equal will be substantially transmitted. Light polarized in a plane parallel to the direction in which the two layers have different indices will be at least partially reflected.

A film having a plurality of layers can include layers with different optical thicknesses to increase the reflectivity of the film over a range of wavelengths. For example, a film can include pairs of layers which are individually tuned (for normally incident light, for example) to achieve optimal reflection of light having particular wavelengths. It should further be appreciated that, although only a single multilayer stack may be described, the multilayer optical film can be made from multiple stacks that are subsequently combined to form the film. Other considerations relevant to making multilayer reflective polarizers are described, for example, in U.S. Pat. No. 5,882,774 to Jonza et al., the disclosure of which is hereby incorporated by reference herein to the extent it is not inconsistent with the present disclosure.

Exemplary suitable diffuse reflective polarizing optical films described, for example, in U.S. Pat. Nos. 5,825,543, 6,057,961, 6,590,705, and 6,057,961, incorporated herein by reference, include a material with a matrix or continuous phase of a first thermoplastic polymer or polymers and a discontinuous or disperse phase of a second thermoplastic polymer or polymers. The matrix, the disperse phase or both may be birefringent.

The first and second polymers are selected to have a large difference between the indices of refraction of the continuous and disperse phases along a first in-plane axis and small along at least one other in-plane axis. More preferably, the first and second polymers are selected to have a large difference between the indices of refraction of the continuous and disperse phases along a first in-plane axis and small along the other two orthogonal axes.

Preferably, the indices of refraction of the first and second polymers are substantially mismatched (differ by more than about 0.05) along the first axis in the plane of the material, and are substantially matched along at least one other axis in the plane of the material (differ by less than about 0.05). More preferably, the indices of refraction are substantially mismatched (differ by more than about 0.05) along the first axis in the plane of the material, and are substantially matched along the other two orthogonal axes (differ by less than about 0.05). The mismatch in refractive indices along a particular axis substantially scatters incident light polarized along that axis, resulting in a significant amount of reflection. In contrast, incident light polarized along an axis in which the refractive indices are matched will be spectrally transmitted or reflected with a much lesser degree of scattering.

The polymers selected for at least one of the continuous and/or disperse phases in the film preferably undergo a change in refractive index as the film is oriented. As the film is oriented in one or more directions, refractive index matches or mismatches are produced along one or more axes. By careful manipulation of orientation parameters and other processing conditions, the positive or negative birefringence of the matrix or the disperse phase can be used to induce diffuse reflection or transmission of one or both polarizations of light along a given axis. Preferably, the diffuse reflectivity of the first and second phases taken together along at least one axis for at least one polarization state of electromagnetic radiation is at least about 30%.

Referring further to FIG. 1, the lighting device 190 further includes a back reflector 120 disposed on the side of the lighting device 190 that faces away from the display panel 180 and a customized retarder 160 (described in more detail below) disposed between the reflective polarizer 170 and the back reflector 120. In the exemplary embodiment illustrated in FIG. 1, the customized retarder 160 is located adjacent the input surface of the reflective polarizer, but that location can be changed depending on a particular application. For example, the customized retarder 160 can be disposed adjacent to the back reflector 120.

Suitable back reflectors include reflectors having a specular reflectivity component, such as specular reflectors, e.g., mirrors. Suitable mirrors include, without limitation, metal-coated mirrors, such as silver-coated or aluminum-coated mirrors or mirror films, polymeric mirror films, such as multilayer polymeric reflective films. Other suitable back reflectors include reflectors having both specular and diffuse reflectivity components. Reflectors having both specular and diffuse reflectivity components include, without limitation, specular reflectors coated with diffuse coatings, reflectors with beaded coatings or white coatings and reflectors having a structured surface. In other exemplary embodiments, the back reflector may be a diffuse reflector. Diffuse reflectors include, but are not limited to particle-loaded plastic films, particle-loaded voided films and back-scattering reflectors.

The lighting device 190 also includes a light source 132 optically coupled to (i.e., is used to illuminate) the input surface 170b of the reflective polarizer 170. Any suitable light source or sources are within the scope of the present disclosure, for example, the light source 132 can be a broadband light source or a light source assembly or assemblies. Light sources suitable for use with the present disclosure include one or more CCFLs, LEDs or light source assemblies including LEDs. The light source 170 is preferably optically coupled to (i.e., is caused to enter) a light-distributing element 134, which in some exemplary embodiments can be a substantially planar or wedge-shaped solid or hollow lightguide. In such exemplary embodiments, light from the light source 132 is coupled into (i.e., caused to enter) an edge 134a of the light-distributing element 134 and, after propagating within the light-distributing element 134, e.g., via TIR, it is coupled out (i.e., caused to exit) through the output side 134b in the direction of the reflective polarizer 170. Although the exemplary embodiment shown in FIG. 1 illustrates one light source used in the display device 100 and lighting device 190, other exemplary embodiments can include two or more light sources or arrays of light sources. If more than one light source is used, one or more light sources may be disposed at different edges of the light-distributing element 134.

The lighting device 190 also includes one or more optical elements 152, 154 and 140 disposed between the reflective polarizer 170 and the back reflector 120. Exemplary additional optical films include, without limitation, structured surface films and one or more diffusers. Preferably, diffusers provided above the reflective polarizer 170 and the back reflector 120, e.g., diffuser 140, are polarization-preserving diffusers. In the exemplary lighting device 190, the additional optical elements include two structured surface films 152 and 154, both having linear prismatic surface structures disposed on the surfaces of the films 152 and 154 that face the reflective polarizer 170. Preferably, the direction of the linear prismatic surface structures of the optical film 152 is orthogonal to the direction of the linear prismatic surface structures of the optical film 154. In other exemplary embodiments, the cavity may include optical films having a structured surface including surface structures of any other useful shape.

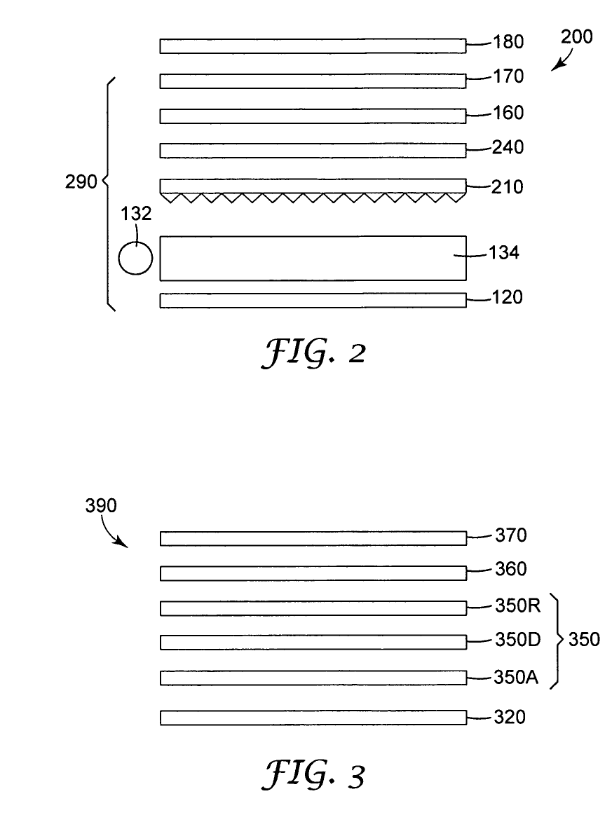

Other additional optical films may be used instead of or in addition to the optical films described above, depending on the application. For example, FIG. 2 shows a display device 200 including a lighting device 290 constructed according to the present disclosure and a display panel 180. The same reference numbers are used in FIG. 2 to refer to elements that are similar to those of FIG. 1. The lighting device 290 includes a diffuser 240 and a structured surface film 210, both disposed between the reflective polarizer 170 and the back reflector 120. In the exemplary lighting device 290, the structured surface film 240 includes linear prismatic surface structures disposed on the surface of the film 240 that faces the back reflector 120. Such structured surface films are sometimes referred to as turning films. In other exemplary embodiments, the structured surface film 290 may include surface structures of any other useful shape disposed on the surface of the film 240 that faces the back reflector 120.

During operation of the exemplary display devices shown in FIGS. 1 and 2, light coupled out of the output side 134b of the light-distributing element 134 and transmitted through the additional optical elements 152-140 and the customized retarder 160 is incident onto the input surface 170b of the reflective polarizer 170. The reflective polarizer 170 transmits at least a substantial portion of light having the first polarization state through its output surface 170b toward the display panel 180 and reflects at least a substantial portion of light having the second polarization state toward the back reflector 120. The reflected light passes through the customized retarder 160, the additional optical elements 152-140, the light-distributing element 134 and is then incident onto the back reflector 120. The back reflector 120, in turn, reflects at least a portion of (preferably, all, substantially all or a substantial portion of) that light back toward the input surface 170b of the reflective polarizer 170.

Customized Retarders

As described above, the reflective polarizer 170 of the lighting devices 190 and 290 described above, reflects light with undesired polarization orientation toward the back reflector 120. If a quarter-wave plate is disposed between a linear reflective polarizer and the back reflector with the slow axis at about 45 degrees with respect to the pass axis of the linear reflective polarizer, the reflected linearly polarized light having the second polarization orientation is converted to circularly-polarized light having a second rotational direction. When that light is specularly reflected by the back reflector, it is converted to circularly-polarized light having a first rotational direction, which has the opposite handedness to the second rotational direction. The quarter-wave plate receives the circularly-polarized light with the first rotational direction and converts it to linearly polarized light with the first linear polarization orientation. The first polarization orientation is collinear with the pass axis of the linear reflective polarizer and is transmitted by the linear reflective polarizer.

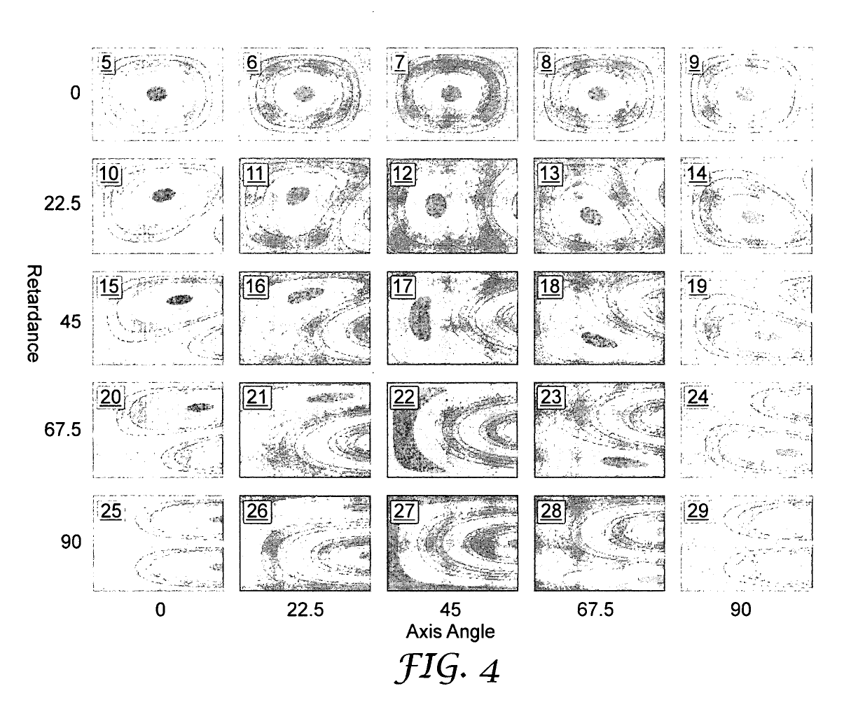

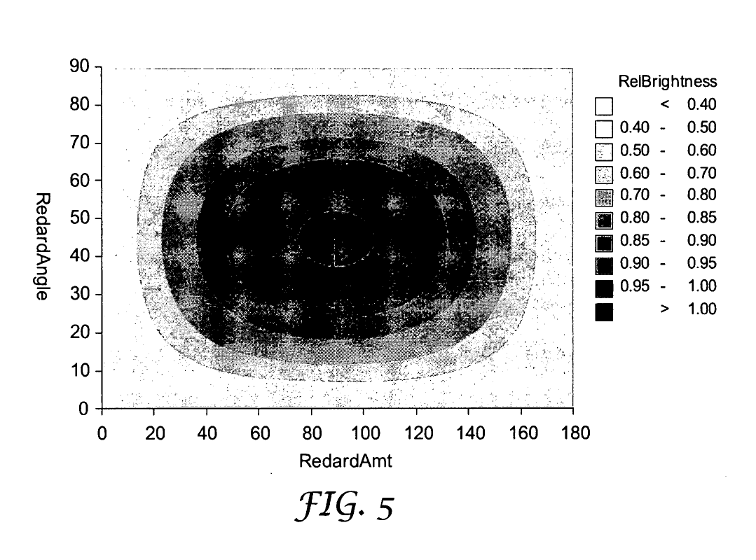

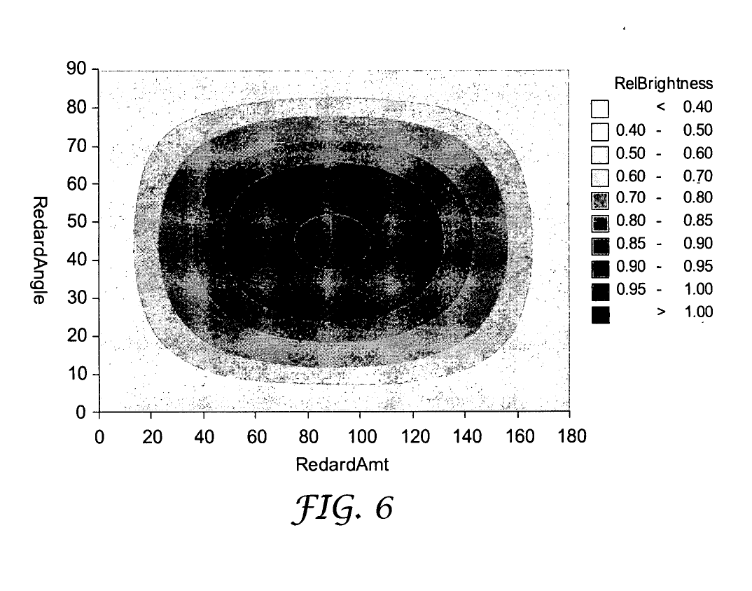

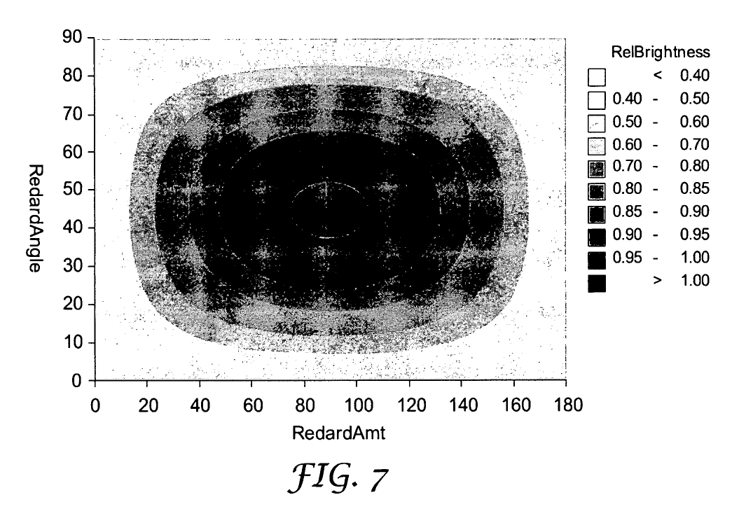

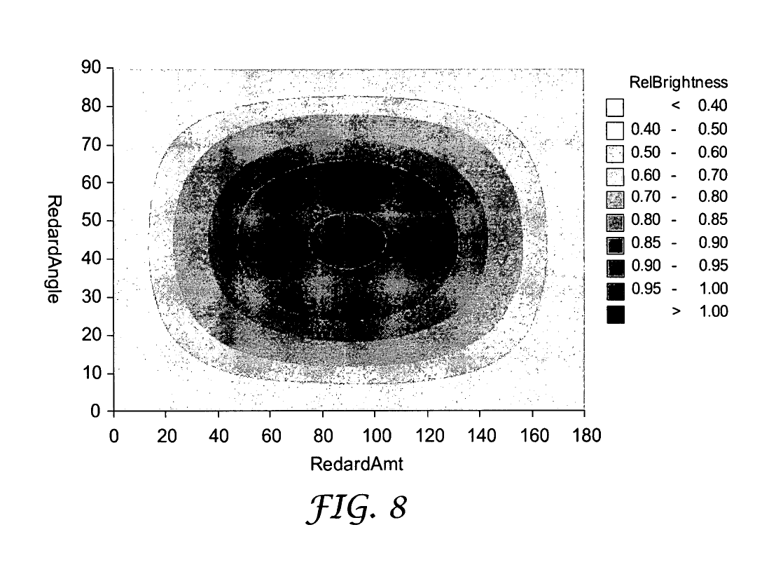

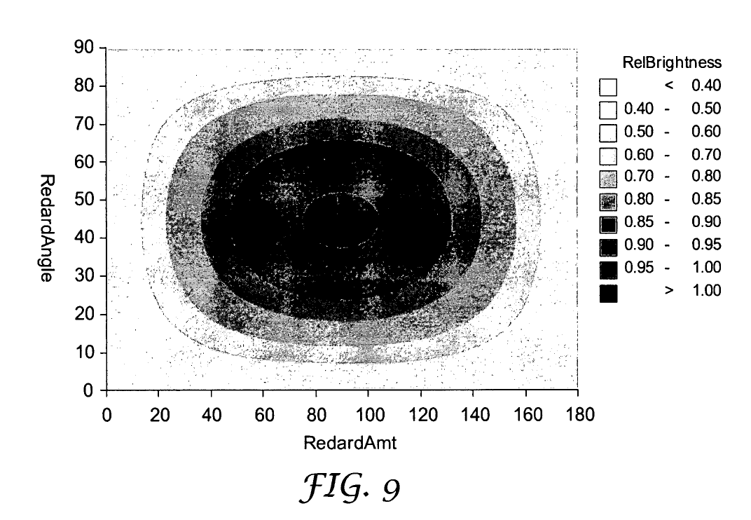

Thus, a quarter-wave plate could increase efficiency of polarization recycling in an optical system that includes no additional optical elements between the reflective polarizer and the back reflector, or if it includes only isotropic additional optical elements. This situation is represented by the top row of modeled plots shown in FIG. 4 and, in more detail, by FIGS. 5-9. There, optimum performance characterized by a high relative brightness is achieved with a quarterwave plate (corresponding to 90° phase retardation amount in the plots) with its slow axis disposed at 45° with respect to the pass axis of the linear reflective polarizer.

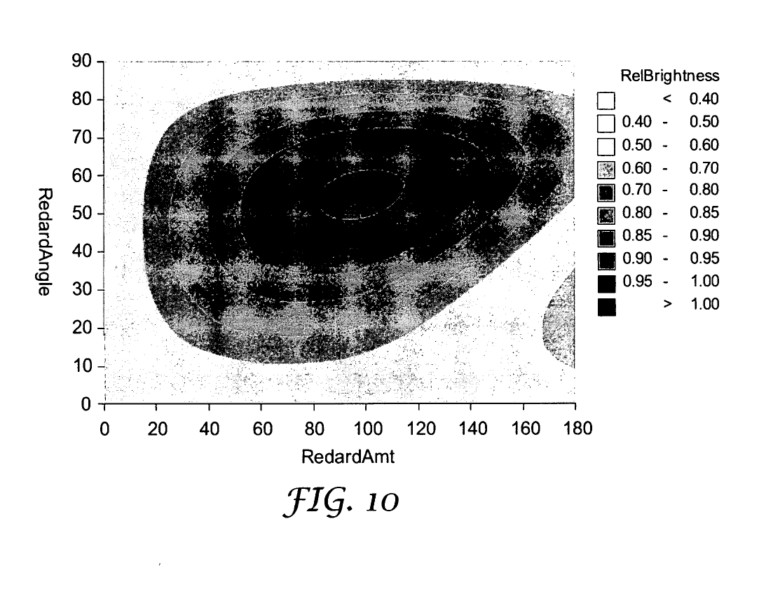

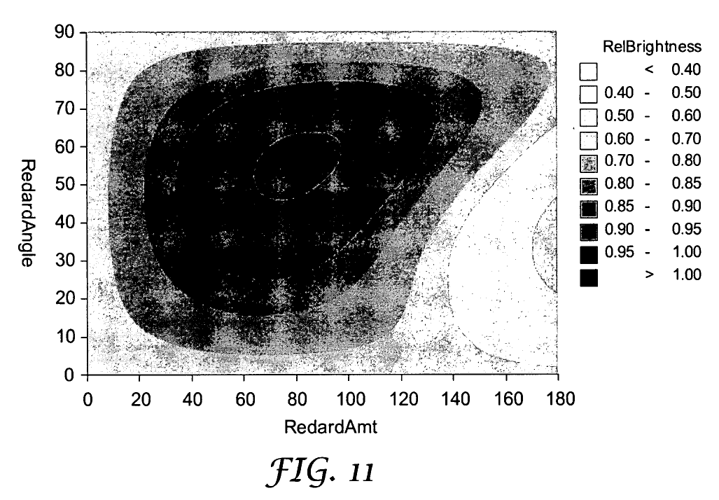

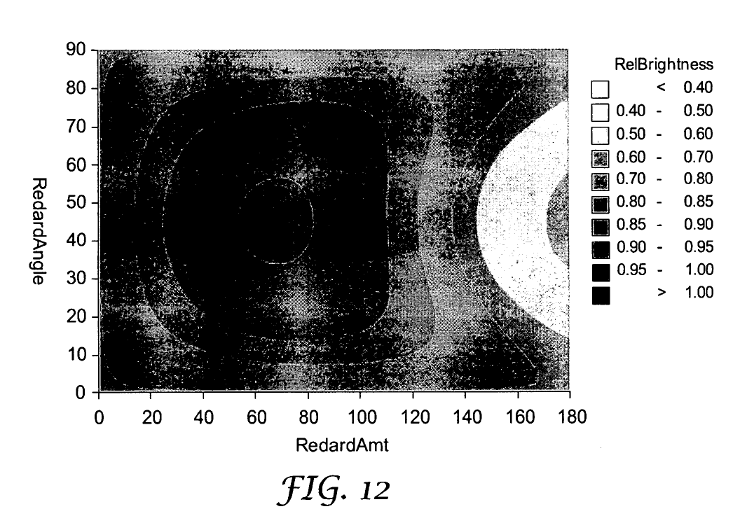

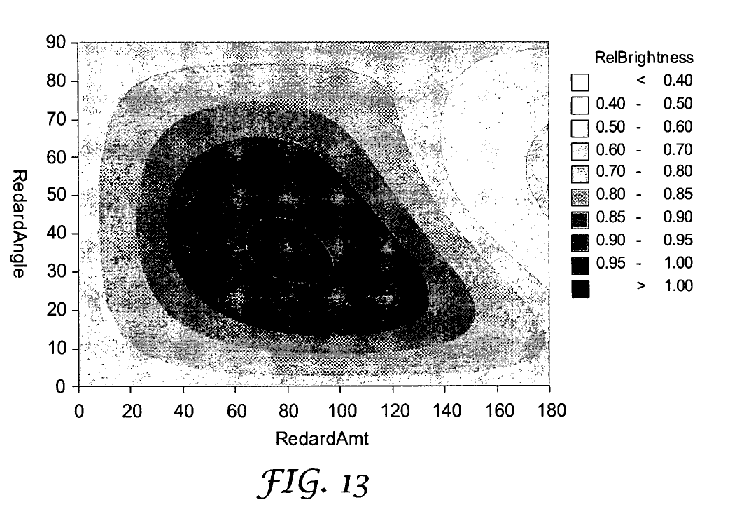

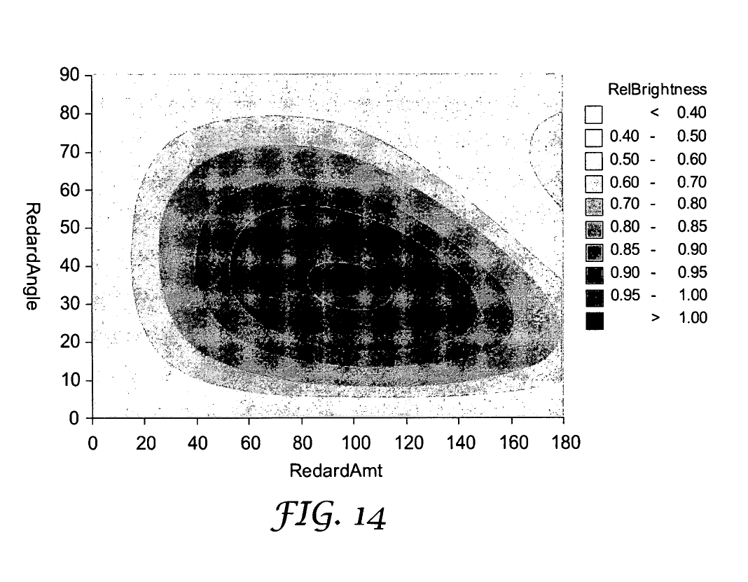

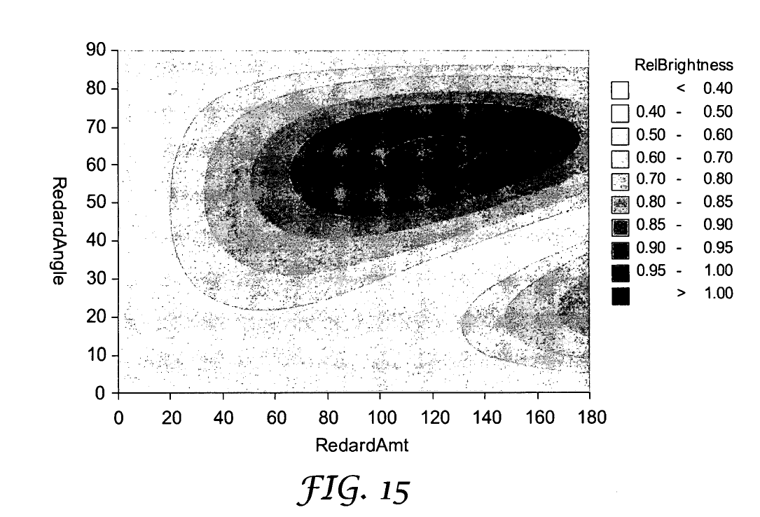

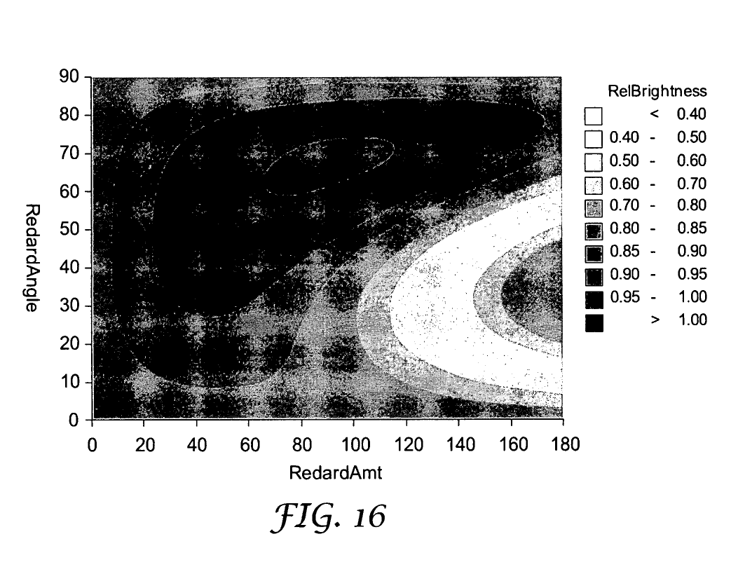

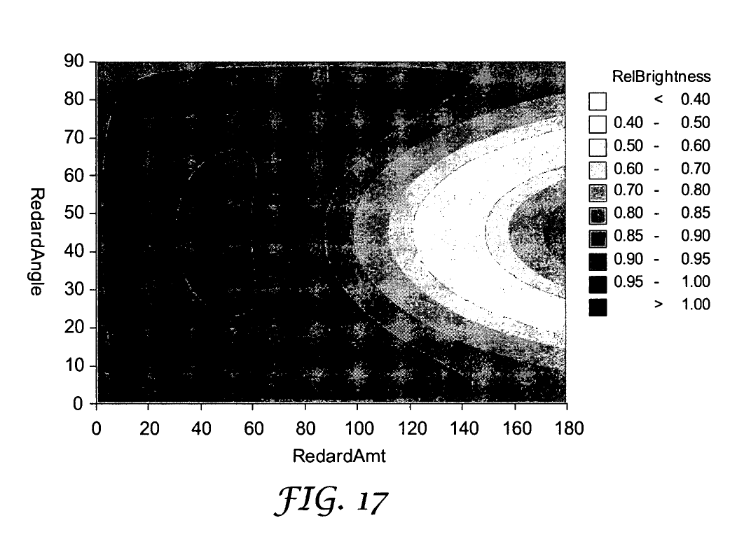

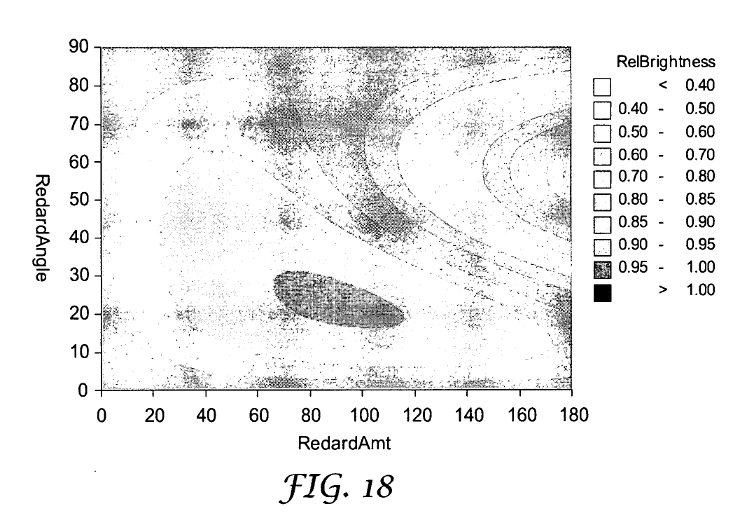

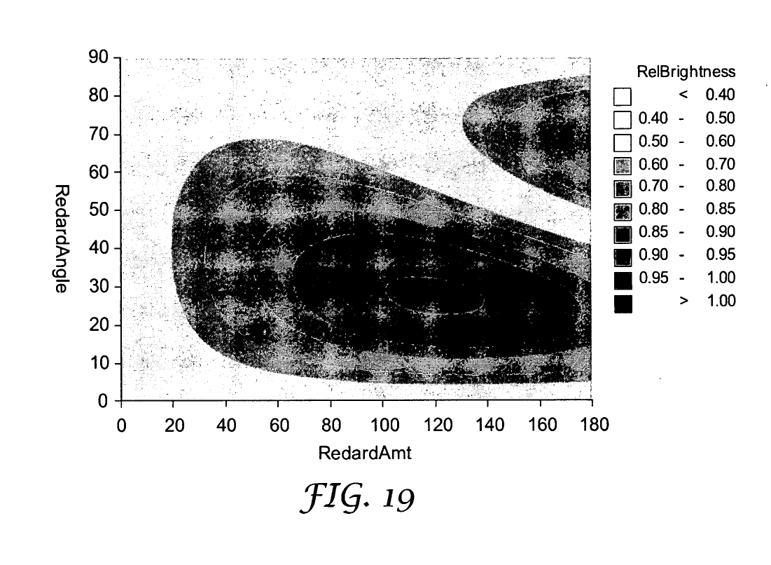

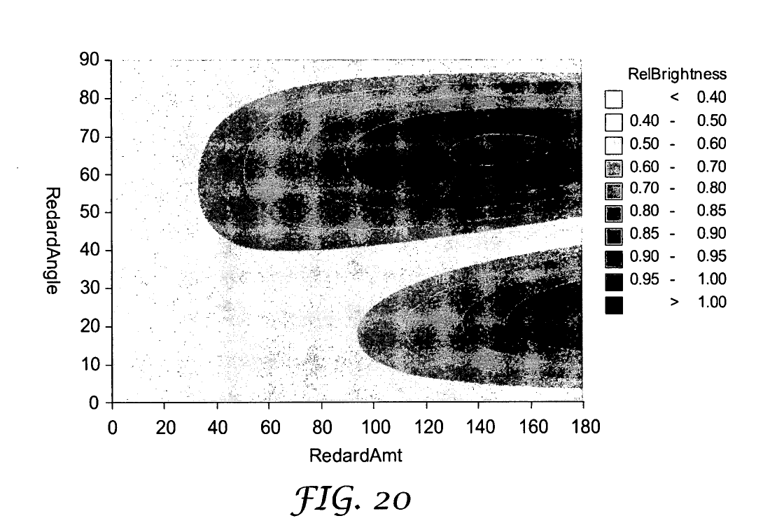

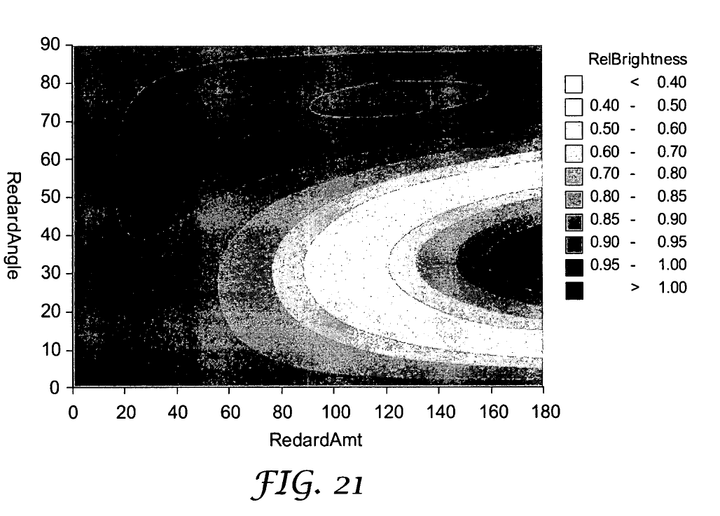

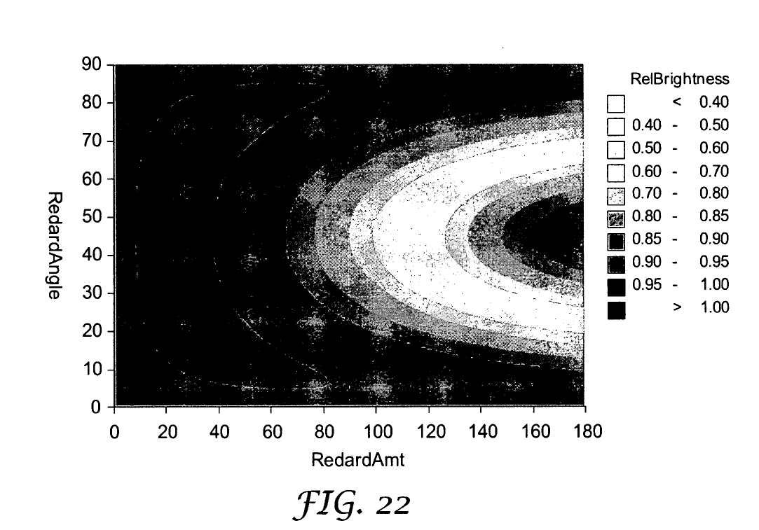

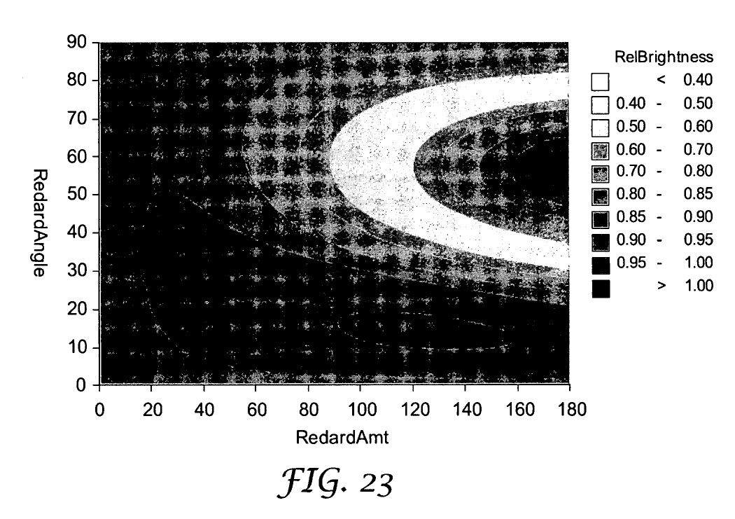

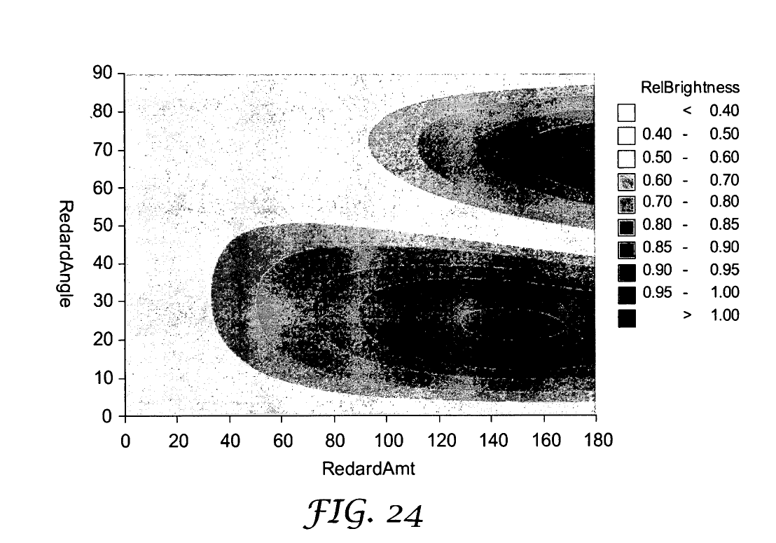

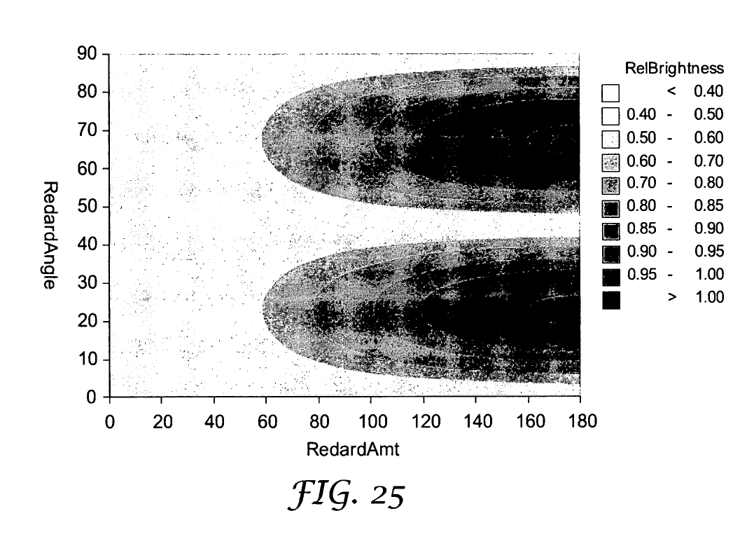

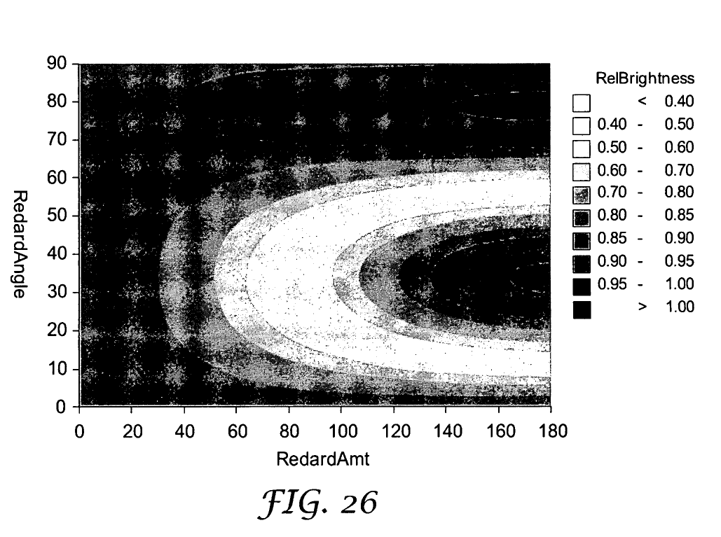

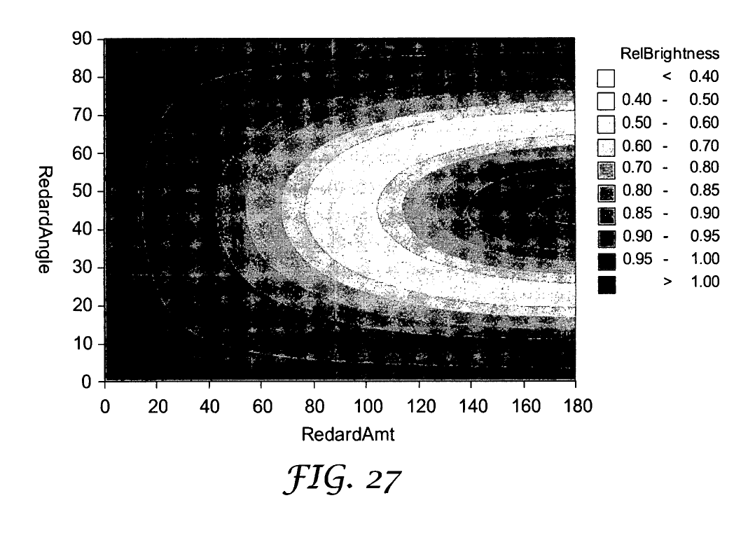

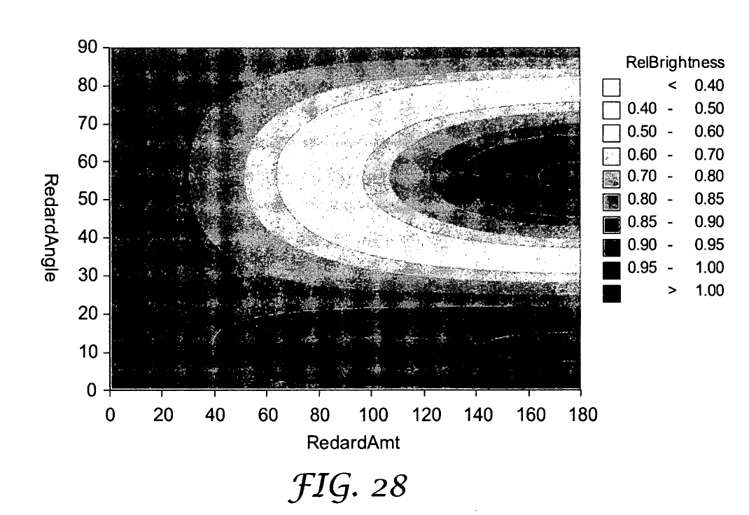

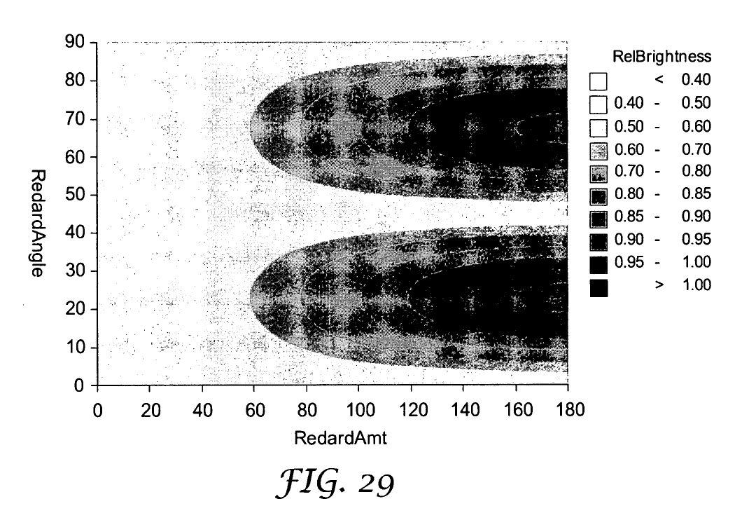

However, most practical optical systems include additional optical elements with a total non-zero in-plane and/or out-of-plane birefringence, which results in total-non-zero retardance experienced by the light passing through such additional optical elements. Performances of lighting systems including an additional optical element with non-zero birefringence are illustrated by the second through fifth rows of the modeled plots shown in FIG. 4, and, in more detail, in FIGS. 10-29. One may observe from these plots that as the total retardance of the additional optical element departs from zero, the optimum performance characterized by high relative brightness is no longer achieved with a quarterwave plate with its slow axis disposed at 45° with respect to the pass axis of the linear reflective polarizer. In some such practical optical systems, where total retardance of the additional optical element becomes significant, a quarter-wave plate could actually decrease the efficiency of polarization recycling.

As it is apparent from FIGS. 4 and 10-29, the maximum of relative brightness shifts further and further away from quarterwave retarder disposed at 45° to the pass axis of the reflective polarizer, as the retardance of the additional optical element is increased. This effect can be observed for all slow axis orientations of the additional optical element. Moreover, light that enters a quarterwave plate at non-normal incidence will have a directionally dependent polarization effect which results in undesirable characteristics of the output that becomes particularly apparent if a substantial portion of light enters the quarterwave plate at non-normal incidence, such as in a backlight including a wedge-shaped lightguide.

Accordingly, typical embodiments of the present disclosure that utilize linear reflective polarizers include a customized non-quarterwave retarder such that the total retardance (Rc+Rs) of the optical elements disposed in the lighting device 190 or 290 between the back reflector 120 and the reflective polarizer 170 (Rs) and that of the customized retarder (Rc) approaches λ/4+nλ/2, where λ is the wavelength of interest and n=0,±1,±2,±3 . . . For the purposes of the present disclosure, it is presumed that any retardance due to the back reflector 120 itself is attributed to an optical element disposed “between the back reflector 120 and the reflective polarizer 170.”

In some exemplary embodiments, two or more birefringent additional optical elements may be present in a lighting device such as a backlight. In some such exemplary embodiments, the two or more birefringent additional optical elements may have slow axes disposed at an angle with respect to each other. In such exemplary lighting systems, it may be advantageous to use a customized retarder that includes two or more retarder films, each retarder film having an optical axis disposed at an angle with respect to the slow axis of another retarder film.

For example, the lighting device may include a first birefringent optical element having a first slow axis and a second birefringent optical element having a second slow axis, the first slow axis disposed at an angle with respect to the second slow axis. In this exemplary lighting deice the customized retarder comprises a first retarder film having a first retarder slow axis and a second retarder film having a second retarder slow axis, the first retarder slow axis disposed at an angle with respect to the second retarder slow axis.

Other exemplary embodiments may include only one birefringent additional optical element or one optical element that has very high birefringence, while birefringence of other optical elements is negligible. In such exemplary embodiments, a single film customized retarder may be used. A single film customized retarder may also be used where two or more birefringent additional optical elements have slow axes that are aligned or approximately aligned with respect to each other. Single film customized retarders also may be used in exemplary lighting devices where optical properties of the one or more birefringent additional optical elements can be approximated as optical properties of a single linear retarder. Those of ordinary skill in the art will understand that other exemplary embodiments are within the scope of the present disclosure.

Generally, λ is the middle or average wavelength of the most useful or any desired wavelength range of the illumination source. For example, when one or more CCFLs are used as the illumination source, is the middle wavelength λ of the desired wavelength range (about 400 to about 700 nm) is about 555 nm. In other exemplary embodiments using light sources characterized by other wavelength ranges, λ can have a different value. For a monochromatic light source, λ is the illumination wavelength. In yet other exemplary embodiments, λ is the middle wavelength of a useful or desirable wavelength sub-range of the illumination source. Specifying a central wavelength around which to evaluate a performance (merit function) for a design is for convenience purposes only. One could alternatively choose to look at multiple wavelengths and use a suitably designed weighted sum and optimize with respect to a suitable average behavior across two, three or more wavelengths.

The total retardance (Rc+Rs) of the optical elements disposed in the lighting device 190 or 290 between the back reflector 120 and the reflective polarizer 170 (Rs) and that of the customized retarder (Rc) can be optimized for any desired angle of incidence. In some exemplary embodiments, the total retardance should be optimized in the direction of the maximum brightness, which typically is the intended viewing direction of the device, but, generally, the retardance can be optimized in any direction or with respect to a performance metric that is an average or a suitably designed weighted sum of retardances along two, three or more directions.

For example, if light traverses the lighting device at angles of or about 90 degrees with respect to the plane of the films in the lighting device (i.e., at or near normal incidence), total in-plane birefringence of the optical elements will have the greatest effect and should be optimized. However, for other angles, both the in-plane and out-of plane total birefringences of the optical elements will contribute to the total retardation experienced by light that traverses the lighting device. For example, in some lighting devices and displays, where the customized retarder is disposed between the back reflector and a turning film or between a reflective polarizer and a wedge-shaped lightguide, both the in-plane and out-of-plane retardance components of the retardance Rc should be optimized for an angle at which a substantial portion of light enters the turning film or exits the wedge-shaped lightguide. In some exemplary embodiments, that angle will be about 75 degrees=/−10 degrees.

The customized retarders of the present disclosure are suited for use in lighting devices that also include at least one optical element having non-zero retardance disposed between the reflective polarizer and the back reflector. In some exemplary embodiments, the total retardance of the one or more additional optical elements is λ/16 or more, λ/8 or more, λ/4 or more, 3λ/8 or more or λ/2 or more. In some exemplary embodiments, it is advantageous if the total retardance of the one or more additional optical elements is substantially uniform over the useful area of the lighting device. FIG. 3 illustrates these and some other physical characteristics of exemplary lighting devices of the present disclosure. More particularly, FIG. 3 shows schematically a lighting device 390, which includes a reflective polarizer 370, a customized retarder 360 having a retardance Rc, additional optical elements 350 and a back reflector 320. The residual retardation Rs of this optical system without the customized retarder 360 is represented by the element 350R, which is also referred to above as retardance of the one or more additional optical elements. Depolarization experienced by light passing through the lighting device 390 is represented by the element 350D.

Depolarization of light may be caused by the back reflector and/or other optical elements. Depolarization is defined as percentage of randomly polarized light in the output beam that has been converted from polarized input beam of light. In typical embodiments of the present disclosure, the amount of depolarization due to the optical elements disposed between the reflective polarizer 370 and the back reflector, for a single pass of light, is no more than 66%, preferably no more than 41%, and more preferably no more than 24%. Absorption of light in the optical elements disposed between the reflective polarizer 370 and the back reflector 320, or by the reflector itself, is represented by the element 350A. In typical embodiments of the present disclosure, the amount of absorption for a single pass of light is at least 10% or at least 20%. The customized retarders of the present disclosure are expected to be particularly useful in lighting devices with significant amounts of absorption.

FIG. 4 and 5-29 show modeled relative brightness contour plots for a system shown schematically in FIG. 3, with a specular back reflector and system absorption of 10% for a single pass of light. All retardance values are also calculated for a single pass of light. The following Table I contains some modeled data used to generate the plots of FIGS. 4-29, which illustrate the conclusion presented above that the maximum of relative brightness shifts further and further away from quarter wave retarder disposed at 45° to the pass axis of the polarizer as the system retardance is increased. Table I shows the retardance(s) Rc of the customized retarder and the angle(s) between its slow axis and the pass axis of the reflective polarizer that results in maximum calculated relative brightness for a particular non-zero system retardance Rs and a particular slow axis orientation of the system with respect to the pass axis of the linear reflective polarizer. The amounts of retardance are shown in degrees and can be converted into fractions of λ according to the formula: (angle in degrees)360°*λ. Orientations of the slow axes are provided in degrees.

TABLE I

| | | | Customized retarder | Maximum |
|---|---|---|---|---|
| | System slow axis | | slow axis | Relative |
| Rs | orientation | Rc | orientation(s) | Brightness |
| 22.5 | 0 | 94 | 64-65 | 0.905 |
| | | 96-100 | 64-66 | |
| | | 102 | 65-67 | |
| 22.5 | 22.5 | 76 | 63-65 | 0.905 |
| | | 78-80 | 63-67 | |
| | | 82 | 64-67 | |
| | | 83 | 65-67 | |
| 22.5 | 45 | 64 | 43-47 | 0.905 |
| | | 66-70 | 42-48 | |
| | | 72 | 45 | |
| 22.5 | 67.5 | 76 | 35-37 | |
| | | 78-80 | 33-37 | |
| | | 82 | 33-36 | |
| | | 83 | 33-35 | |
| 22.5 | 90 | 94 | 35-36 | 0.905 |
| | | 96-100 | 34-36 | |
| | | 102 | 33-35 | |
| 45 | 0 | 116-124 | 72-73 | 0.905 |
| 45 | 22.5 | 84-96 | 76-78 | 0.905 |
| 45 | 45 | 42 | 40-50 | 0.905 |
| | | 44-46 | 38-52 | |
| | | 48 | 39-51 | |
| 45 | 67.5 | 84-96 | 22-24 | 0.905 |
| 45 | 90 | 116-124 | 27-28 | 0.905 |
| 67.5 | 0 | 144-154 | 66-67 | 0.905 |
| 67.5 | 22.5 | 116-134 | 86-87 | 0.905 |
| 67.5 | 45 | 18 | 42-48 | 0.905 |
| | | 20 | 33-57 | |
| | | 22 | 29-61 | |
| | | 24 | 26-64 | |
| | | 26 | 24-66 | |
| | | 28 | 23-67 | |
| | | 30 | 22-29 and 61-68 | |
| | | 32 | 22-25 and 65-68 | |
| 67.5 | 67.5 | 116-134 | 13-14 | 0.905 |
| 67.5 | 90 | 144-154 | 23-24 | 0.905 |
| 90 | 0 | 176-180 | 67-68 | 0.905 |
| | | | 22-23 | |
| 90 | 22.5 | 170-180 | 78-79 | 0.905 |
| | | 176-180 | 33-34 | |
| 90 | 45 | 0-4 | Any | 0.905 |
| | | any | 0-1 or 89-90 | |
| | | 176-180 | 44-46 | |
| 90 | 67.5 | 176-180 | 56-57 | 0.905 |
| | | 170-180 | 11-12 | |
| 90 | 90 | 176-180 | 67-68 | 0.905 |
| | | | 22-23 | |

Exemplary optical elements suitable for use as customized retarders according to the present disclosure include, without limitation, polymeric retarders, e.g., oriented polymeric retarders, liquid crystal polymer retarders, e.g., lyotropic liquid crystal retarders, and any number or combination thereof. More particularly, exemplary customized retarders may include a simultaneously biaxially stretched polymer film layer, such as a polyolefin film layer, that is non-absorbing and non-scattering for at least one polarization state of visible light. Some optical films suitable for use as customized retarders are described in U.S. Application Publication Nos. 2004/0156106 and 2004/0184150, the disclosures of which are hereby incorporated by reference herein. Customized retarders may be extruded, solvent cast or produced by another method.

Those skilled in the art will readily observe that numerous modifications and alterations of the exemplary embodiments of the present disclosure may be made while retaining the teachings of the invention. For example, in any of the exemplary embodiments of the present disclosure, the components illustrated may be disposed at different locations within the lighting device than those shown. Any two or more components may be laminated to each other as may be desired for a particular application. Accordingly, the above disclosure should be construed as limited only by the metes and bounds of the appended claims.

What is claimed is:

1. A lighting device comprising:
a light source;
a linear reflective polarizer having an input surface optically coupled to the light source and an output surface disposed opposite the input surface, the linear reflective polarizer being configured to transmit at least a substantial amount of light having a first polarization state and reflect at least a substantial amount of light having a second polarization state different from the first polarization state;
a back reflector configured and disposed to reflect light that has been reflected by the linear reflective polarizer back toward the input surface thereof;
one or more optical elements having a total non-zero retardance Rs and disposed between the linear reflective polarizer and the back reflector;
a customized retarder having a retardance Rc such that a total retardance of the one or more optical elements and the customized retarder, Rs+Rc, approaches λ/4+nλ/2;
wherein the one or more optical elements, the customized retarder and the back reflector are characterized by a total depolarization of no more than 66%.

2. The lighting device of claim 1, wherein the one or more optical elements include at least one of: a structured surface film and a diffuser.

3. The lighting device of claim 1, wherein the back reflector is a specular reflector.

4. The lighting device of claim 1, wherein the one or more optical elements, the customized retarder and the back reflector are characterized by a total depolarization of no more than 41%.

5. The lighting device of claim 1, wherein Rs is λ/8 or more.

6. The lighting device of claim 1, wherein the one or more optical elements, the customized retarder and the back reflector are characterized by a total absorption of at least 10%.

7. A display device comprising a lighting device according to claim 1 and a display panel optically coupled to the output surface of the linear reflective polarizer.

8. The lighting device of claim 1, wherein the one or more optical elements include a first birefringent optical element having a first slow axis and a second birefringent optical element having a second slow axis, the first slow axis disposed at an angle with respect to the second slow axis, and wherein the customized retarder comprises a first retarder film having a first retarder slow axis and a second retarder film having a second retarder slow axis, the first retarder slow axis disposed at an angle with respect to the second retarder slow axis.

9. A lighting device comprising:
a light source;
a linear reflective polarizer having an input surface optically coupled to the light source and an output surface disposed opposite the input surface, the linear reflective polarizer being configured to transmit light having a first polarization state and reflect light having a second polarization state different from the first polarization state;
a back reflector configured and disposed to reflect light that has been reflected by the linear reflective polarizer toward the input surface thereof;
a light distributing element disposed between the back reflector and the linear reflective polarizer having an input facet optically coupled to the light source and an output facet optically coupled to the input surface of the linear reflective polarizer and one or more optical films disposed between the back reflector and the linear reflective polarizer, wherein the light-distributing element and the one or more optical films have a non-zero total retardance Rs;
a customized retarder having a retardance Rc such that the total retardance of the light-distributing element, the one or more optical films and the customized retarder, Rs+Rc, approaches λ/4+nλ/2;
wherein the light-distributing element, the one or more optical films, the customized retarder and the back reflector are characterized by a total depolarization of no more than 66%.

10. The lighting device of claim 9, wherein the one or more optical films include at least one of: a structured surface film and a diffuser.

11. The lighting device of claim 9, wherein the back reflector is a specular reflector.

12. The lighting device of claim 9, wherein the one or more optical films, the customized retarder and the back reflector are characterized by a total depolarization of no more than 41%.

13. The lighting device of claim 9, wherein Rs is λ/8 or more.

14. The lighting device of claim 9, wherein the one or more films elements, the customized retarder and the back reflector are characterized by a total absorption of at least 10%.

15. A display device comprising a lighting device according to claim 9 and a display panel optically coupled to the output surface of the linear reflective polarizer.

16. The lighting device of claim 9, wherein the one or more optical films include a first birefringent optical film having a first slow axis and a second birefringent optical film having a second slow axis, the first slow axis disposed at an angle with respect to the second slow axis, and wherein the customized retarder comprises a first retarder film having a first retarder slow axis and a second retarder film having a second retarder slow axis, the first retarder slow axis disposed at an angle with respect to the second retarder slow axis.

17. A lighting device comprising:
a light source;
a linear reflective polarizer having an input surface optically coupled to the light source and an output surface disposed opposite the input surface, the linear reflective polarizer being configured to transmit light having a first polarization state and reflect light having a second polarization state different from the first polarization state;
a back reflector configured and disposed to reflect light that has been reflected by the linear reflective polarizer toward the input surface thereof;
one or more optical elements having a total non-zero retardance Rs and disposed between the back reflector and the linear reflective polarizer;
a customized retarder disposed adjacent to the linear reflective polarizer and having a retardance Rc such that the total retardance of the one or more optical elements and the customized retarder, Rs+Rc, approaches λ/4+nλ/2;
wherein the one or more optical elements, the customized retarder and the back reflector are characterized by a total depolarization of no more than 66%.

18. The lighting device of claim 17, wherein the one or more optical elements include at least one of: a structured surface film and a diffuser.

19. The lighting device of claim 17, wherein the back reflector is a specular reflector.

20. The lighting device of claim 17, wherein the one or more optical elements, the customized retarder and the back reflector are characterized by a total depolarization of no more than 41%.

21. The lighting device of claim 17, wherein Rs is λ/8 or more.

22. The lighting device of claim 17, wherein the one or more optical elements, the customized retarder and the back reflector are characterized by a total absorption of at least 10%.

23. A display device comprising a lighting device according to claim 17 and a display panel optically coupled to the output surface of the linear reflective polarizer.

24. The lighting device of claim 17, wherein the one or more optical elements include a first birefringent optical element having a first slow axis and a second birefringent optical element having a second slow axis, the first slow axis disposed at an angle with respect to the second slow axis, and wherein the customized retarder comprises a first retarder film having a first retarder slow axis and a second retarder film having a second retarder slow axis, the first retarder slow axis disposed at an angle with respect to the second retarder slow axis.
